(19) United States
(12) Patent Application Publication
(10) Pub. No.: US 2013/0057492 A1
(43) Pub. Date: Mar. 7, 2013

(54) INFORMATION DISPLAY APPARATUS AND METHOD

(71) Applicants: Takahide Kubota, Izunokuni-shi (JP); Katsuhito Mochizuki, Mishima-shi (JP); Masanori Sambe, Mishima-shi (JP)

(72) Inventors: Takahide Kubota, Izunokuni-shi (JP); Katsuhito Mochizuki, Mishima-shi (JP); Masanori Sambe, Mishima-shi (JP)

(73) Assignee: TOSHIBA TEC KABUSHIKI KAISHA, Tokyo (JP)

(21) Appl. No.: 13/597,353

(22) Filed: Aug. 29, 2012

(30) Foreign Application Priority Data
Sep. 6, 2011 (JP) 2011-193721

(51) Int. Cl. G06F 3/041; G09G 5/00

(52) U.S. Cl. 345/173; 345/156

(57) ABSTRACT

An information display apparatus comprises a display unit, a position recognition unit configured to recognize the position where a operator operates the display unit and a sub-screen display unit configured to display the sub-screen on the display unit and on the position correspond to the position of the operator identified by the position recognition unit.

### CROSS-REFERENCE TO RELATED APPLICATION

This application is based upon and claims the benefit of priority from Japanese Patent Application No. 2011-193721, filed Sep. 6, 2011, the entire contents of which are incorporated herein by reference.

### FIELD

Embodiments of this invention relates to an information display apparatus and method.

### BACKGROUND

In the past commercial facilities such as shopping mall and underground street, the content about advertisements or event information and so on are displayed on the digital signage terminal device.

The vending machine with a large liquid crystal display and a touch panel changes the display position according to the height of the operator (referring to Patent Document 1).

### BRIEF DESCRIPTION OF THE DRAWINGS

FIG. 1 is a schematic diagram showing a shopping mall which applies a digital signage terminal device in an embodiment;

FIG. 2 is a front side view showing the design of the digital signage terminal device in the embodiment, wherein, FIG. (A) representing the overall apparatus, and FIG. (B) representing the enlarged drawing of the display unit;

FIG. 3 is a block diagram showing the summary structure of the digital signage terminal device;

FIG. 4 is a block diagram showing functions of the MPU;

FIG. 5 is a view exemplarily illustrating the display position of the sub-screen of the digital signage terminal device, wherein (A) representing the sub-screen before displaying and (B) representing the sub-screen after displaying;

FIG. 6 is a view showing the position relation between the sub-screen displayed on the digital signage terminal device and the operator;

FIG. 7 is a flow chart showing the display processing of the sub-screen of the digital signage terminal device and the operator in this embodiment;

FIG. 8 is a view showing the range picked-up by the camera unit in the digital signage terminal device and the position relation between the operator and the reader, wherein, (A) representing the position relation between the operator and the reader and (B) representing the silhouette of the operator and the reader of the picked-up image dada;

FIG. 9 is a flow chart showing other processing of the sub-screen of the digital signage terminal device in the embodiment.

### DETAILED DESCRIPTION

According to this embodiment, An information display apparatus comprises a display unit, a position recognition unit configured to recognize the position where a operator operates the display and a sub-screen display unit configured to display the sub-screen on the display unit and on the position correspond to the position of the operator identified by the position recognition unit.

According to this embodiment, a digital signage terminal device will be illustrated with reference to the accompanying drawings. In addition, the information processing system is constructed by a digital signage terminal device used for shopping malls. Moreover, an information processing system is constructed into a digital signage terminal device which is used in the shopping mall.

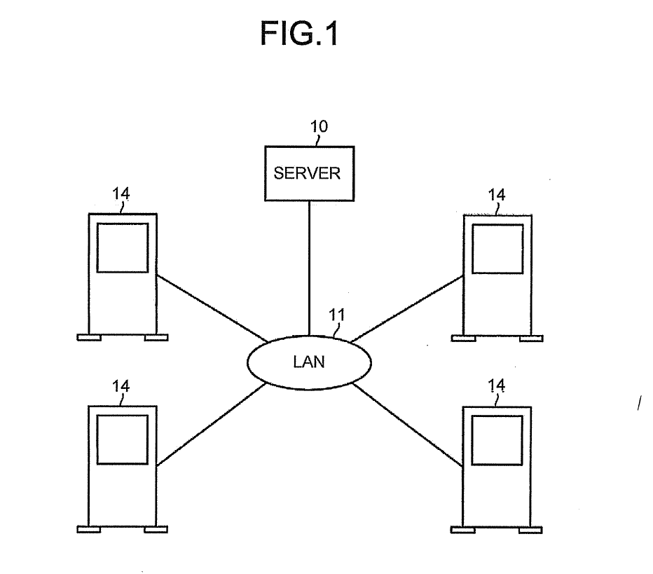

FIG. 1 is a schematic diagram showing a shopping mall which applies a digital signage terminal device in the embodiment. A plurality of digital signage terminal devices 14 including the advertisement contents connects to a server 10 which is configured to store various data and sends the advertisement contents of commodity to the digital signage terminal device 14, through LAN 11.

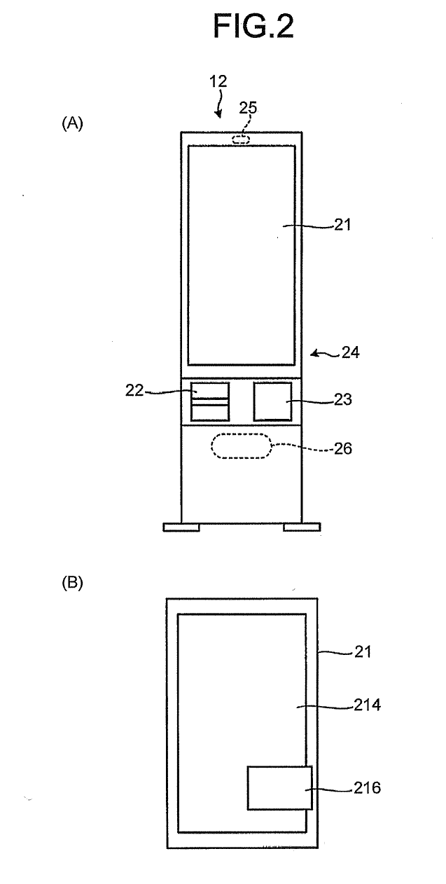

FIG. 2 (A) is a front side view showing the design of the digital signage terminal device. The digital signage terminal device 14 comprises a display 21 constructed by a touch panel being a liquid crystal display or a plasma display panel; a printer 22 configured to print various receipts and coupons; a reader 23 configured to read the customer ID information of the storage medium including member cards; a supporting display unit 21, a printer 22 and a box body 24 of the reader 23.

The upper of the box body 24 composes of a camera 25 configured to recognize image carried out by a picked-up operator and generate picked-up image data used for determining the display position of the following operated screen; a speaker 26 configured to output various audios such as BGM and advertisement sound. Further, instead of the digital signage terminal device 14 the image recognition processing may be carried out by the server 10.

For the printer unit 22, a printer apparatus which utilizes a thermal recording way being using roller paper as recording medium may has a cutting section that automatically cuts roller paper, considering the demand.

FIG. 2 (B) is a view showing the enlarged drawing of the display unit 21. Under a normal usage status, the display unit 21 displays advertisement contents 214 and sub-screens 216 which considering the operation of the operator, overlaps on the advertisement contents 214, such as an aftermentioned operation screen and a result screen.

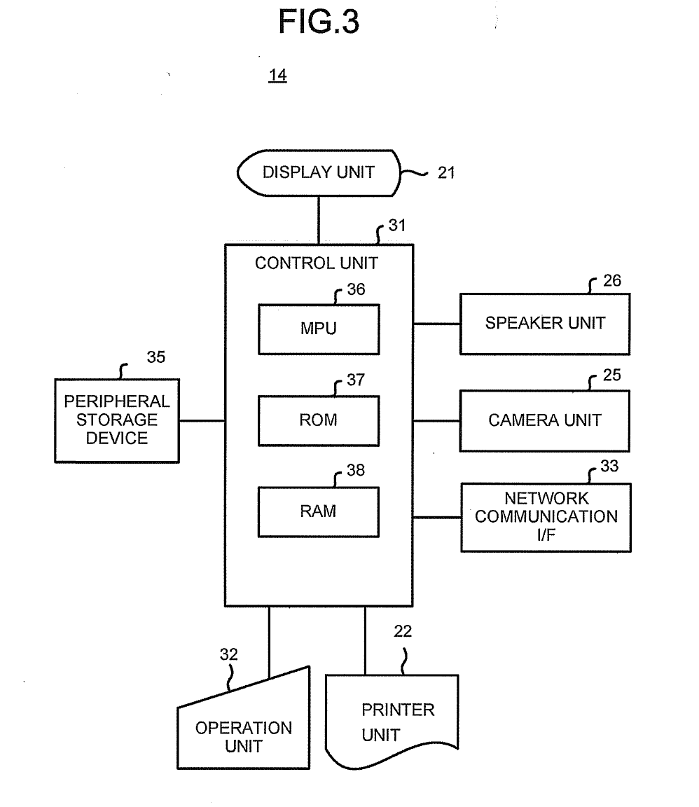

FIG. 3 is a block diagram showing the summary structure of the digital signage terminal device. The digital signage terminal device 14 has a control unit 31 configured to control the all units of the digital signage terminal device, a operation unit 32 configured to provide various operation for the operator or the user, a communication interface (IF) 33 configured to execute communication with the server 10 through the LAN 11 and a peripheral storage device 35 configured to store various data besides a display 21, a printer 22, a camera 25, and a speaker 26.

The control unit 31 has a MPU 36 configured to control the overall units of the control unit 31, a ROM 37 configured to store a control procedure for the action of the MPU 36 and a RAM 38 configured to temporarily store various data.

Moreover, the operation unit 32 may contain various switches and buttons, or may be integrated with the display unit 21 which is crystal display and the like as touch panels.

In addition, the peripheral storage device 35 may also utilize the storage unit in the server 10.

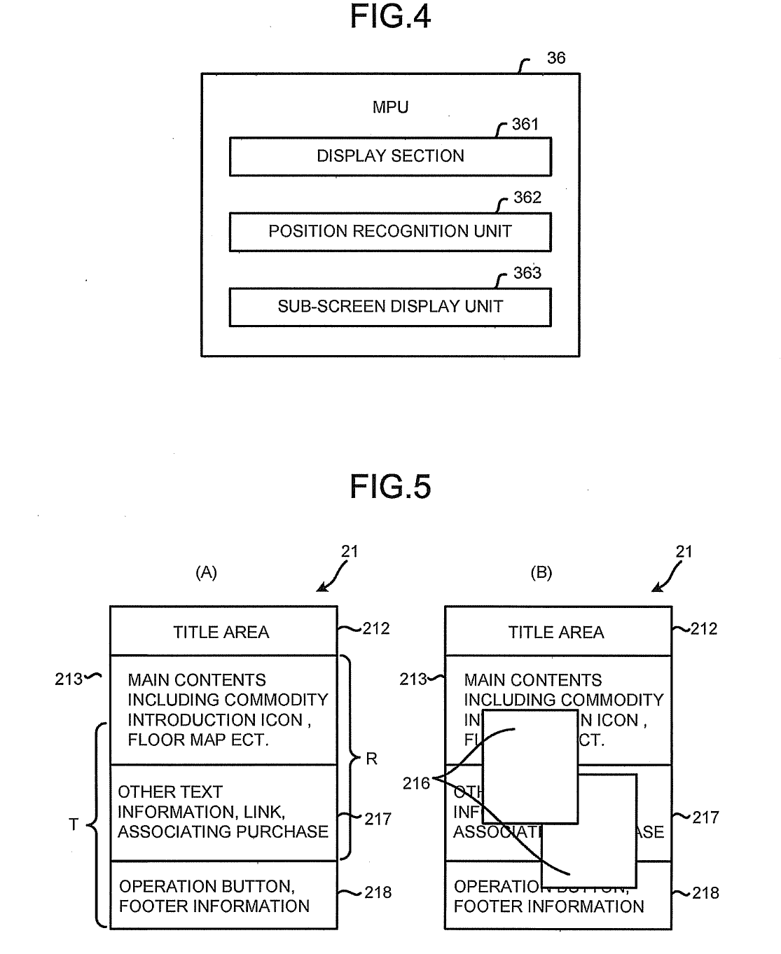

FIG. 4 is a block diagram showing the function of the MPU 36. The MPU 36 contains a display section 361 configured to display advertisement contents on the display unit 21, a position recognition unit 362 configured to recognize the position of the operator based on the image dada picked-up by the camera 25 and a sub-screen display unit 363 configured to display the sub-screen on the determined display position.

FIG. 5 is a view exemplarily illustrating the position of the sub-screen 216 displayed on the display unit 21 of the digital signage terminal device 14. FIG. 5 (A) represents the status that the display unit 21 displays normal advertisement contents. In addition, the display status is same as the former status that the digital signage terminal device displays the advertisement contents.

In the examples as shown in FIG. 5 (A), the screen displayed on the display unit 21 is vertically divided into a title area 212 configured to display the title of the advertisement contents, a main content area 213 including commodity introduction icons centered in advertisement contents and a stores guide centered in the shopping, a associating display area 217 configured to display the information additional to the main contents and a operation button footer information area 218 configures to display operation buttons and footer information from up to down.

Moreover, as shown in FIG. 5 (A), in the digital signage terminal device 14 which displays the operation button on the operation button footer information area 218, and to utilize the operation buttons to comprehensively execute the operation of the operator, the operation screen of the sub-screen may be partly displayed. In this embodiment, the operation of the operator may be achieved by utilizing the operation buttons or by utilizing the operation screen which is considered as the sub-screen.

When the operator operates the digital signage terminal device 14, inmost cases, they touch the region which is shown in FIG. 5 (A) and represented by T. In the former digital signage terminal device, according to the operation of the operator, the displayed sub-screen 216 is enlarged impressively in the region represented by the letter R in FIG. 5 (A), therefore making the reader easy to see the contents retrieved by the operator.

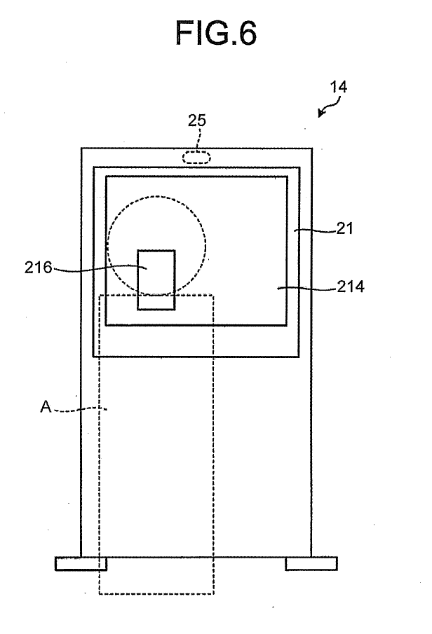

However, in the digital signage terminal device 14 in the embodiment, as shown in FIG. 5 (B) and in the aftermentioned FIG. 6, the sub-screen 216 displays as a small screen floatingly on the position hidden by the silhouette of the operator.

FIG. 6 is a view showing the position relation between the sub-screen 216 displayed on the display unit 21 of the digital signage terminal device 14 and the operator A.

In the digital signage terminal device 14 in the embodiment, the sub-screen 216 is displayed on the position correspond to the operator A, that is, on the position facing the operator A which is not easy for the surrounding readers (B, C in FIG. 8) to recognize, that is, on the position which is hidden by the silhouette of the operator A from the angle of the observers. The sub-screen 216 overlapping on the advertisement contents 214 usually displayed adjusts the position displayed, by the touch operation of the operator A, the position of the sub-screen 216 displayed on the display unit 21 may be adjusted as will from up to down or from left to right.

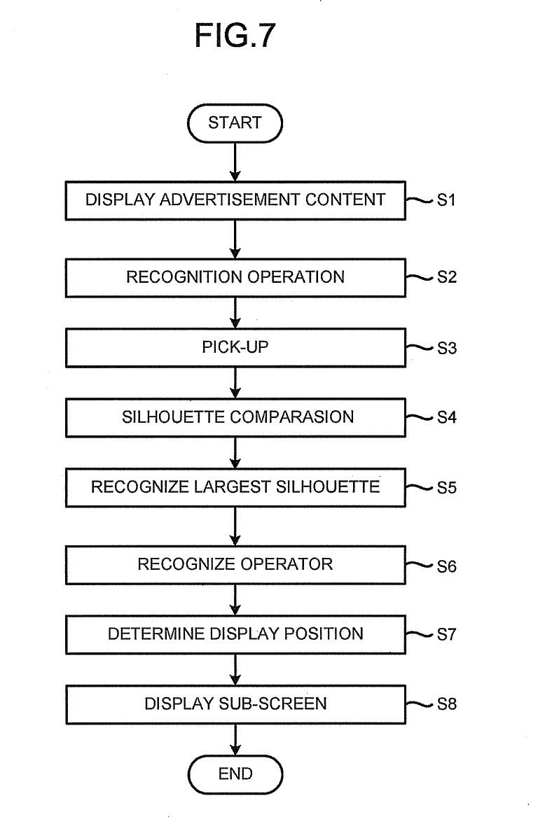

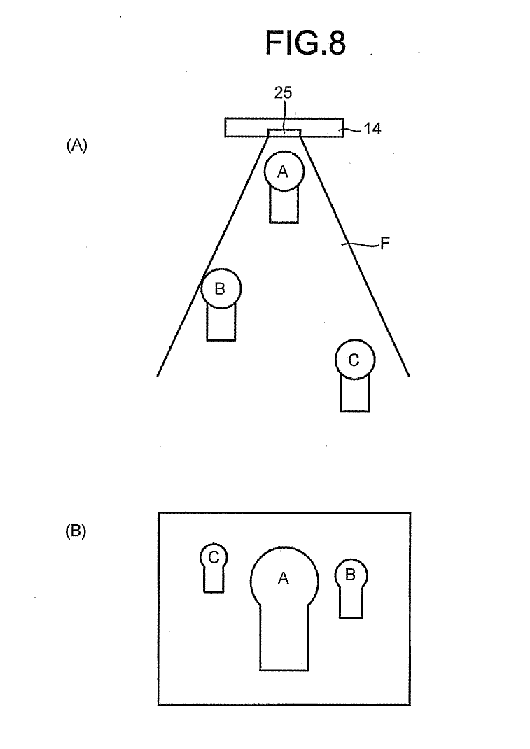

FIG. 7 is a flow chart showing the display processing of the sub-screen 216 of the digital signage terminal device 14 in this embodiment.

First, in Act 1, usual advertisement's content is displayed. Specifically, the MPU36 (display section 361) of the digital signage terminal device 14 loads the data of the advertisement contents stored in the peripheral storage device 35, thereby displaying the advertisement contents on the display unit 21.

Next, in Act 2, recognize the operation of the operator A. after the finger of the operator A touches the display unit 21 which is considered as the touch panel, the sent information is the information which touches from the display unit 21 to the MPU 36. In addition, this operation may also be that the operator inserts a member card into the digital signage terminal device 14.

Next, in Act 3, the pick-up of the operator is executed. Specifically, the MPU 36 receiving the touched information makes the camera 25 carry out a pick-up image in the given picked-up range.

Next, in Act 4, the comparison of the silhouettes in the picked-up range is carried out. Specifically, as shown in FIG. 8 (A), in case that there are a plurality of characters such as A, B, C in the picked-up range of the camera 25, there are A, B, C in the picked-up image data as shown in FIG. 8 (B). In this case, the picked-up image data of the camera 25 is sent to the MPU36 and the silhouette of the operator is identified through the MPU36. In the embodiment, the silhouettes of character A, character B, characters C are identified.

The character silhouette's recognition which from picked-up image data, for example, in case that there are parts equal to a head, a body, a foot and a hand in the picked-up image data, the MPU36 recognize the region consecutive to these parts as character silhouette, therefore recognizing the character silhouette with the picked-up image data. or, in case that there are parts equal to a character face, parts being a eye, a nose or a mouth, in the picked-up image data, the MPU 36 identifies the region consecutive to the character face as the character silhouette.

Next, in Act 5, recognize the largest silhouette among the identified silhouette. Specifically, the MPU 36 identifies the silhouette which occupies the largest pixels proportion of the three silhouettes, that is, in the case as shown in FIG. 8 (B) the MPU 36 identifies the silhouette of character A.

Next, in Act 6, recognize the operator. Specifically, the MPU 36 identifies the character A with the largest silhouette as the operator.

Next, in Act 7, determine the display position of the sub-screen 216. Specifically, the MPU 36 (position recognition unit 362) in the region of the display unit 21 determines the largest overlapping region between the silhouette of the operator A in the image data and the sub-screen 216 as the display position of the sub-screen 216. Moreover, the determination of display position is not limited to this, for example, the MPU 36 may recognize the head according to the silhouette of the operator A, and then determine the largest overlapping region between the head displayed on the display unit 21 and the sub-screen 216 as the display position of the sub-screen 216.

Next, in Act 8, on the display unit 21 displays the sub-screen 21. Specifically, the MPU 36 (sub-screen display unit 363) loads the image data corresponding to the classes (operation screen, result screen) of the sub-screen 216 stored in the ROM37 and control the display unit 21 in manner of displaying the sub-screen 216 on the position determined in Act 7 where the sub-screen 216 is displayed the display position displaying the sub-screen 216 in Act 7.

According to the embodiment, the digital signage terminal device 14, as shown in FIG. 6, the sub-screen is displayed on the position correspond to the operator from the angle of the surrounding observers, that is, on the position which is hidden by the shadow of the operator, therefore the operator may operate the digital signage terminal device regardless of the surrounding observers, further protecting the privacy of the operator.

In addition, the embodiment of this invention is illustrated as an example and is not intended to limit the scope of the invention. The new embodiment can be implemented in other various embodiments. Various omissions, alterations, and modifications can be made without deviating from the gist of the invention. The embodiment or its variations is included in the scope of the invention, and included in the invention described in the claims and its equivalent.

For example, in the embodiment, the position of the operator may be identified based on the image data picked-up by the camera 25, but not limited to this, or based on the position touched by the operator on the display unit 21.

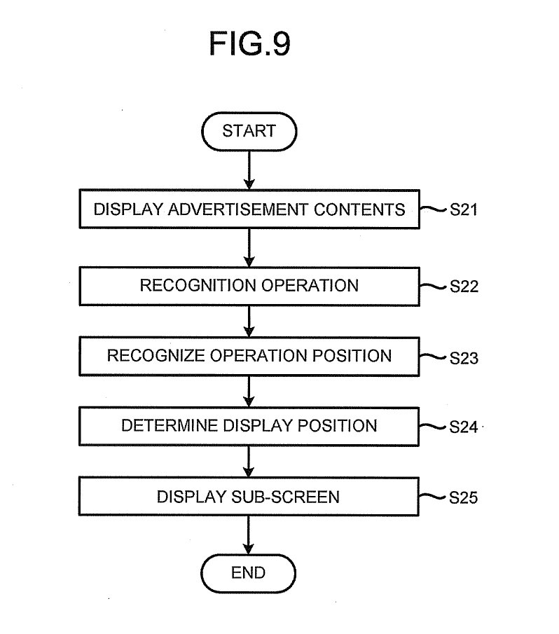

FIG. 9 is a flow chart showing other processing of the sub-screen 216 of the digital signage terminal device 14 in the embodiment. In the displaying processing shown in FIG. 9, the position of the operator is identified based on the position touched by the operator. In addition, S21 and S22 in the flow chart shown in FIG. 9 are same as S1 and S2 in the flow chart shown in FIG. 7 and are therefore not repeatedly described here.

First, after Act S21 and Act S22, the operation position recognition is carried out in S23. Specifically, after the operator touches with fingers the display unit 21, the display unit 21 sends information representing the touched position to the MPU36 (position recognition unit 362), thus the MPU36 recognizing the touched position.

Next, in Act 24, the position of the sub-screen is determined. Specifically, the touched position identified in Act 23 is changed to the center position of the sub-screen 216, determining the display position of the sub-screen 216.

Next, in Act 25, the sub-screen 216 displays on the determined display position. Specifically, the MPU 36 (sub-screen display unit 363) loads the image data corresponding to the classes (operation screen, result screen) of the sub-screen 216 stored in the ROM37 and control the display unit 21 in manner of displaying the sub-screen 216 on the position determined in Act 24 where the sub-screen 216 is displayed.

The digital signage terminal device in the embodiment shown in FIG. 9, displays the sub-screen on the position correspond the operator from the angle of the surrounding observers, that is, on the position which is hidden by the shadow of the operator and therefore is not easy for the surrounding readers to see, therefore the operator may operate the digital signage terminal device regardless of the surrounding observers, further protecting the privacy of the operator.

In addition, there is s case where the determined display position is near the button end of the display region of display unit 21, and if the sub-screen 216 is displayed on the above-mention position, the total sub-screen 216 may not be displayed. In this case, if the position which is closest to the touched position identified in Act 23 is made center showing the sub-screen 216, make the position displaying the total sub-screen 216 position as the center to display the sub-screen. Or, if the total sub-screen 216 may not be displayed, display it on its position and then the operator moves the sub-screen 216 as will.

In this embodiment, the execution program of the information display apparatus is a module formation including the mentioned units (display section 361, position recognition unit 362, and sub-screen display unit 363); as the actual hardware, the MPU and the CPU reads from the ROM and executes the program, therefore uploading the display section 361, the position recognition unit 362 and the sub-screen unit 363, further generating each unit on the major storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information display apparatus, comprising:
a display unit;
a position recognition unit configured to recognize the position where a operator operates the display unit; and
a sub-screen display unit configured to display the sub-screen on the display unit and on the position correspond to the position of the operator identified by the position recognition unit.

2. The information display apparatus according to claim 1, wherein
the position recognition unit is a image picked-up unit which has a given recognition range and determines the largest silhouette as the silhouette of the operator in the given recognition range, thus recognizing the position of the operator.

3. An information display apparatus according to claim 1, wherein
the position recognition unit is arranged on the touch panel of the display unit;
the position of the touch panel on which the operator touches is identified as the position of the operator.

4. The information display apparatus according to claim 1, wherein
the sub-screen displayed on the display unit may be moved from up to down or from right to left by the operator.

5. An information display apparatus according to claim 1, wherein
the sub-screen contains at least either of the operation screen for the operation of the operator and the result screen providing operation result information according to the requirement of the operator.

6. A method, comprising:
recognizing the position where a operator operates a display unit; and
displaying the sub-screen on the display unit and on the position correspond to the position of the operator identified.
